(19) United States
(12) Patent Application Publication
(10) Pub. No.: US 2016/0256717 A1
(43) Pub. Date: Sep. 8, 2016

(54) SANDWICH PANEL HAVING FIRE-EXTINGUISHING FUNCTION AND CONSTRUCTION WALL USING THE SAME

(71) Applicant: YOUNG HAK JOUNG, Gyeonggi-do (KR)

(72) Inventor: YOUNG HAK JOUNG, Gyeonggi-do (KR)

(21) Appl. No.: 15/058,908

(22) Filed: Mar. 2, 2016

(30) Foreign Application Priority Data
Mar. 4, 2015 (KR) 10-2015-0030337

(51) Int. Cl. A62C 3/00; A62C 35/68; E04B 1/94

(52) U.S. Cl. CPC A62C 3/00; E04B 1/942; E04B 1/947; A62C 35/68

(57) ABSTRACT

A sandwich panel according to the present invention comprises a pair of exterior panels spaced from each other; an insulating material filled between a pair of exterior panels; an upper heat insulating plate and a lower beat insulating plate made of a material having a higher melting point than the combustion heat of the insulating material and inserted to cross the insulating material horizontally; and a water pipe made of a material capable of melting by the combustion heat of the insulating material and inserted between the upper heat insulating plate and the lower heat insulating plate. If the sandwich panel according to the present invention O and a construction wall using the same are used, a fire may be quickly suppressed since water is sprayed on the insulating material side when the insulating material is on fire due to the outbreak of fire. The fire caught on the insulating material is prevented from being diffused in an upper side, thereby reducing damage due to the fire. Water supply is available without installation of separate water pipes, thus allowing easier construction of buildings.

### CROSS-REFERENCE TO RELATED APPLICATIONS

This application claims the benefit of Korean Patent Application 2015-0030337 filed on Mar. 4, 2015 with the Korean Intellectual Property Office, the disclosure of which is hereby incorporated by reference in its entirety.

### BACKGROUND

1. Technical Field

The present invention relates to a sandwich panel filled with an insulating material within exterior panels spaced from each other and to a construction all using the same. More particularly, the present invention relates to a sandwich panel capable of automatically achieving a fire-extinguishing function at the outbreak of fire and to a construction wall using the same.

2. Description of the Related Art

Sandwich panels are used widely because the construction period is short, the working is simple and the construction cost is low. Thus, the sandwich panels can greatly reduce the construction cost as compared with conventional constructional materials. The sandwich panels contain insulating materials in the inside thereof, thus exhibiting excellent insulation effects. The sandwich panels exhibit 21.5 times larger insulation effects than red bricks and 49 times lamer insulation effects than concretes. Therefore, the sandwich panels are the most economical prefabricated construction materials which can greatly reduce the maintenance costs.

In addition, since the sandwich panels are not substantially damaged when disassembling, they can be reused. They can be assembled and disassembled using bolts and nuts or screws, thus exhibiting good workability. Further, the sandwich panels have advantages in that beautiful appearance may be achieved by inserting various shapes, colors, patterns or the like into exterior panels.

Since the sandwich panels have excellent: advantages over other construction materials as described above, they are widely used in a large amount for the construction of prefabricated housing and 95% or more of the industrial facilities including plants, cold storage warehouses, logistical warehouses and the like which can be constructed into a prefabricated type.

Thus, the sandwich panels are configured such that the insulating material such as Styrofoam foamed with a synthetic resin is filled between exterior panels in order to obtain the effects of keeping warm, heat insulation and soundproofing. The exterior panels are usually made of a metal and thus is fire-resistive, However, the Styrofoam insulating material has a disadvantage in that it is a flammable material and thus causes rapidly fire spreading at the breakout of fire.

Especially, since the fire caught on the insulating material is hidden by the exterior panel made of a metal, the fire caught on the insulating material is not easily extinguished even though the fire-fighting water is sprayed on the sandwich panel side. Further, since it: is hard to confirm, with the unaided eye from the outside, whether the insulating materials are burning, there is a problem that a fire may break out again due to a fire residue remaining on the insulating material.

Further, conventional sandwich panels cannot be built in water pipes. Therefore, when a construction wall is constructed using sandwich panels, there is an inconvenience that water pipes should be installed separately.

### PRIOR ART DOCUMENT

[Patent Document] Korean Patent No. 10-0636890 B1

### SUMMARY

It is an object of the present invention to solve the above-described problems encountered with the prior arts and to provide a sandwich panel in which, at the outbreak of fire, the fire can be quickly suppressed by spraying water to the insulating material side, the fire caught on the insulating material can be prevented from being diffused; and water can be supplied, without separately installing water pipes, thereby protecting the lives and property.

It is another object of t le present invention to provide a construction wall using the above sandwich panel.

In order to achieve the above objects, the present invention provides a sandwich panel comprising: a pair of exterior panels spaced from each other; an insulating material filled between a pair of exterior panels; an upper Feat insulating plate and a lower heat insulating plate made of a material having a higher melting point than the combustion heat of the insulating material and inserted to cross the insulating material horizontally; and a water pipe made of a material capable of melting by the combustion heat of the insulating material and inserted between the upper heat insulating plate and the lower heat insulating plate.

The sandwich panel according to the present invention further comprises: a water supply valve for opening and closing a passage of the water pipe, and a temperature detecting sensor for outputting an operational signal of the water supply valve so that water is supplied to the water pipe when the temperature of the exterior panel or the insulating material is detected and the detected temperature is over a predetermined reference value.

A sandwich panel according to the present invention comprises: a pair of exterior panels spaced from each other; an insulating material filled between a pair of exterior panels; a water pipe made of a nonflammable material so as to have a pipe shape, and formed of a plurality of through holes; and a water supply valve for controlling water supply into the water pipe.

The construction wall according to the present invention comprises: a sandwich panel configured as above; a coupling member which includes a coupling insulating material of a square pillar shape, a coupling exterior panel coupled so as to cover at least one of outside surfaces of the coupling insulating material, a coupling upper heat insulating plate and a coupling lower heat insulating plate lade of a material having a higher melting point than the combustion heat of the coupling insulating material to cross the coupling insulating material horizontally, and a coupling water pipe made of a material capable of melting by the combustion heat of the coupling insulating material, into as shape of 3-way valve or 4-way valve, and inserted between the coupling upper heat insulating plate and the coupling lower heat insulating plate, thereby coupling two sandwich panels arranged orthogonally; and a cap coupled detachably so as to seal a port of the coupling water pipe, wherein the water pipe of the sandwich panel, is connected to communicate with the coupling water pipe of the coupling member.

In the case of using the sandwich panel according to the present invention and the construction wall using the same, when catching lire in the inside of the insulating material due to the outbreak or fire, water is sprayed on the insulating material side and thus the fire may be quickly suppressed. The fire caught on the insulating material can be prevented from being diffused upwardly, thereby reducing the damage due to the fire. Water supply becomes possible without installation of separate water pipes, thereby allowing easier construction of buildings.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of the sandwich panel according to the present invention.

FIG. 2 is a perspective view of a sandwich panel in Which a heat insulating plate and a water pipe are drawn out.

FIG. 3 is a horizontal cross-sectional view showing an installation structure of the sandwich panel according to the present invention.

FIG. 4 is a perspective view of a coupling member included in a construction wall according to the present invention.

FIG. 5 is a horizontal cross-sectional view of a construction wail according to the present invention.

FIG. 6 is a cross-sectional view of as construction wall according to the second embodiment of the present invention.

FIG. 7 is a perspective view of the sandwich panel according to the second embodiment of the present invention.

FIG. 8 is a perspective view of a water pipe included in the sandwich panel according to the third embodiment of the present invention.

FIG. 9 is a perspective view of the sandwich panel according to the third embodiment of the present invention.

### DETAILED DESCRIPTION

Hereinafter, the configuration and operation of preferred embodiments of the present invention will be described in detail with reference to the accompanying drawings. Here, in the case of assigning the reference numerals to the components of the drawings, it should be noted that, with respect to the same components, the same reference numerals are used even in different drawings.

Now, embodiments of a sandwich panel and a construction wall using the same in accordance with the present invention will be described in detail with reference to the accompanying drawings.

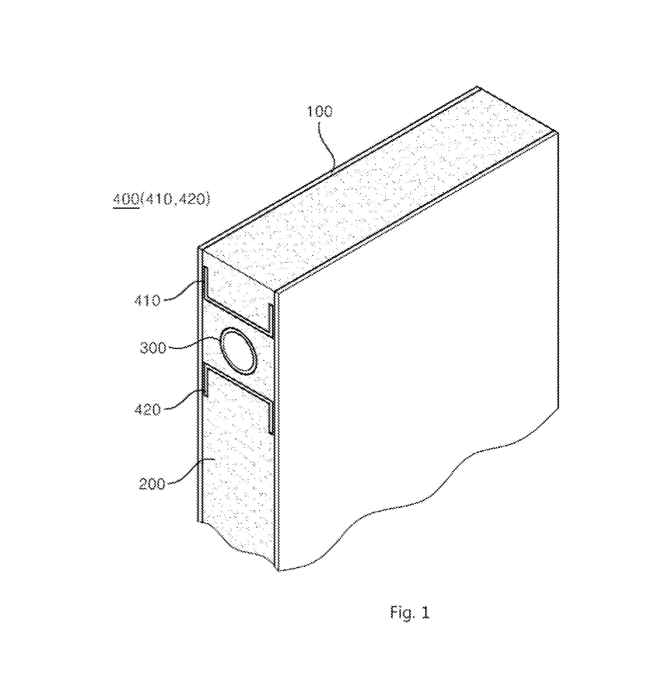

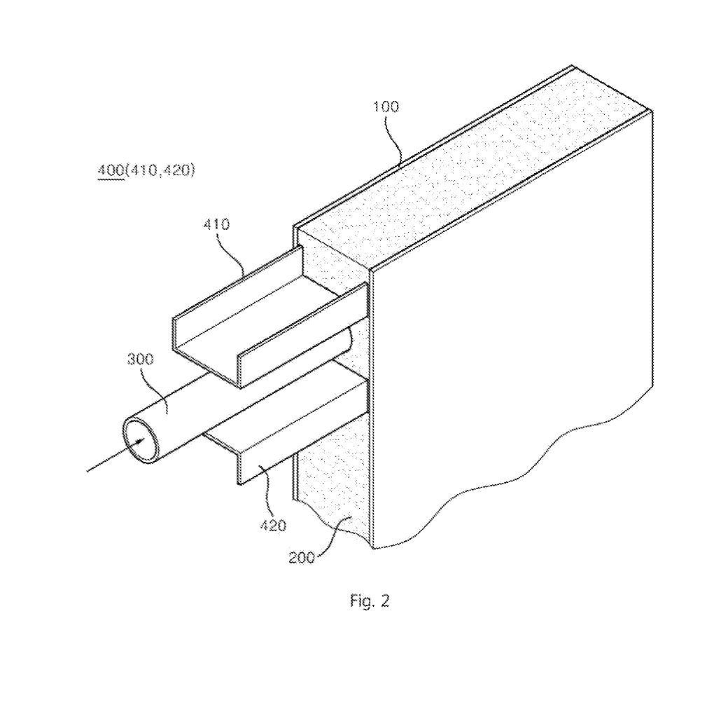

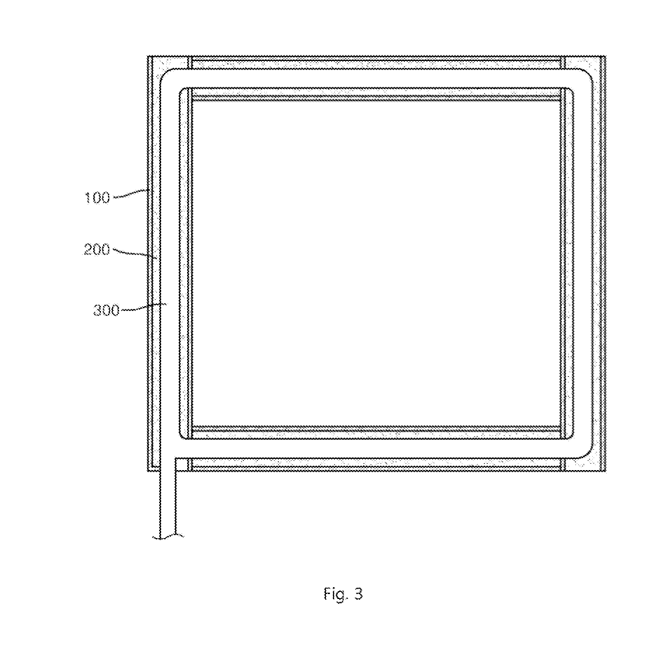

FIG. 1 is a perspective view of a sandwich panel according to the present invention, FIG. 2 is a perspective view of a sandwich panel in which a heat insulating plate and a water pipe are drawn out, and FIG. 3 is a horizontal cross-sectional view showing an installation structure of a sandwich panel according to the present invention.

A sandwich panel according to the present invention is a building material for the construction wall consisted of a structure in which an insulating material 200 is filled between a pair of exterior panels 100 spaced so as to be parallel to each other. The most important feature is that the sandwich panel is configured such that, when the insulating material 200 is burnt at the outbreak of fire, the fire can be suppressed by spraying water on the side of the insulating material 200.

That is, the sandwich panel according to the present invention has a constitutional characteristic in that a water pipe 300 made of a material capable of melting by the combustion heat of the insulating material 200 is additionally provided in the upper side of the insulating material 200 filled between a pair of exterior panels 100. In this case, the water pipe 300 may be made of various kinds of materials such as rubber or synthetic resin if the water pipe can be melted when the combustion heat of the insulating material 200 is applied while having water-resistance at room temperature, and it may also be made into a polygon shape including a triangle, a quadrangle or the like.

If the water pipe 300 is built-in and installed inside the insulating material 200, water in the water pipe 300 is not usually discharged, however, if the insulating material 200 burns, the water pipe 300 melts and water in the water pipe 300 is discharged downwardly, thereby suppressing the burning of the insulating material 200. That is, the sandwich panel according to the present invention has an advantage that damage due to fire can be greatly reduced by discharging the fire-extinguishing water itself when the insulating material 200 is burning. Especially, when it is difficult to exactly spray water between a pair of exterior panels 100, the usefulness of the sandwich panel according to the present invention further increases.

Meanwhile, a heat insulating plate 400 inserted to cross the insulating material 200 horizontally may be provided so as to minimize a phenomenon in which the fire caught on the insulating material 200 of the sandwich panels is propagated to another sandwich panel. The heat insulating plate 400 is divided into an upper heat insulating plate 410 inserted in an upper part of the water pipe 300 and a lower heat insulating plate 420 inserted in a lower part of the water pipe 300. The upper heat insulating plate 410 and the lower heat insulating plate 420 are made of a material having a higher melting point than the combustion heat of the insulating material 200 such that they are not melted by the combustion heat of the insulating material 200. If the heat insulating plate 400 crossing the insulating material 200 horizontally is provided, the fire caught on the insulating material 200 is blocked and no longer diffused upwardly, thus preventing a massive fire.

Of course, when the insulating material 200 is melted and the lower heat insulating plate 420 is dropped down, the water pipe 300 is melted by the combustion heat of the insulating material 200 and water in the water pipe 300 is discharged, thus suppressing the fire. It is preferable that both the upper heat insulating plate 410 and the lower heat insulating plate 420 are formed to have a shaped cross-section by being bent orthogonally on both sides in the width direction.

Further, a plurality of sandwich panels according to the present invention may be connected and utilized as a wall of a building structure. If the water pipe 300 is formed in a linear shape, water pipes 300 included in two sandwich panels cannot be connected to each other when two sandwich panels are arranged orthogonally. If the water pipes 300 are not connected as above, every water pipe 300 is not filled with water when water is supplied to any water pipe 300, thus causing a serious problem that fire-fighting effect cannot be achieved.

Accordingly, as shown in FIG. 3, the water pipe 300 included in the sandwich panel may he formed in a linear shape (see water pipes 300 arranged in upper and lower sides), the longitudinal both sides may be bent orthogonally and the tip may be formed in a shape divided into two branches (see water pipes 300 arranged in left side).

If the water pipes 300 are formed in various shapes as described above, a user may connect all water pipes 300 integrally, by selecting the sandwich panels having the water pipe 300 with a suitable shape when connecting a plurality of sandwich panels. In this to case, the water pipe 300 can he formed in any shape other than those disclosed in this embodiment.

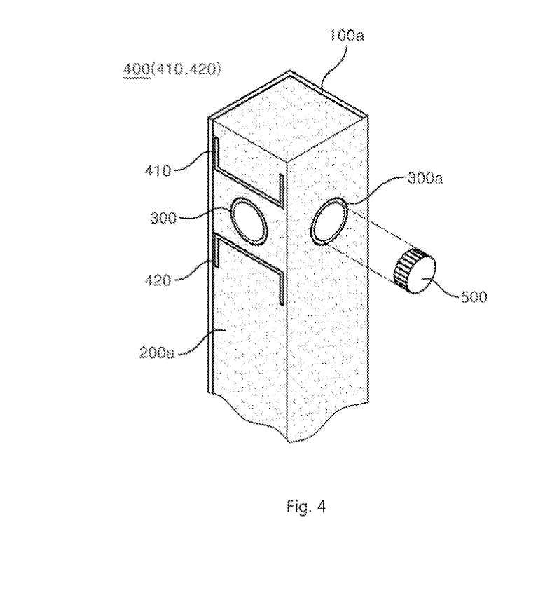

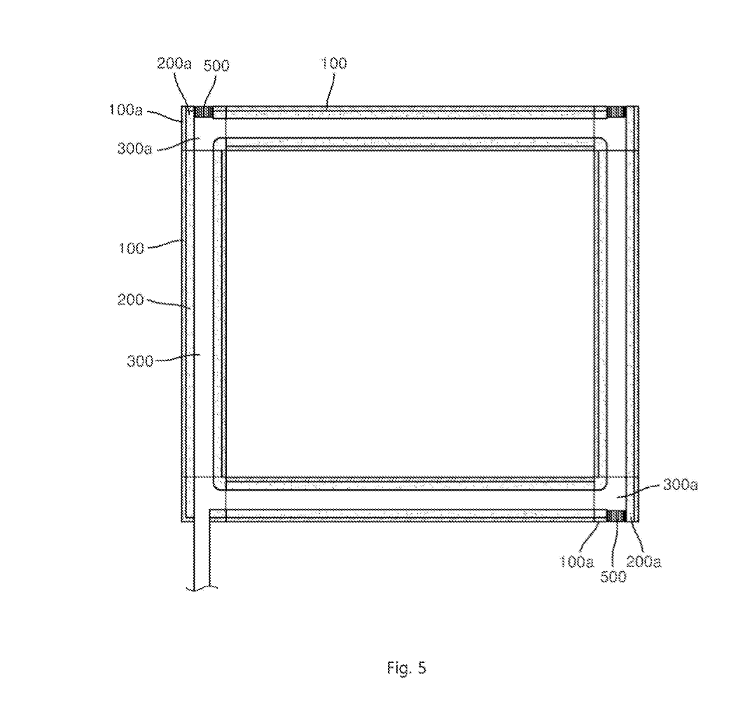

FIG. 4 is a perspective view of a coupling member included in a construction wall according to the present invention, and FIG. 5 is a horizontal cross-sectional view of a construction wall according to the present invention.

As shown in FIG. 3, if the sandwich panels are manufactured to have different water pipes 300, many times and costs are required to prepare the sandwich panel. Further, many times are required even when preparing a construction wall by connecting the sandwich panels.

Accordingly, although the water pipes 300 of the sandwich panels are formed in a linear shape, a coupling member for coupling the ends in the width direction of two sandwich panels may be further provided so that two sandwich panels different from each other can be connected orthogonally. That is, a construction wall according to the present invention is not only simply consisted of only sandwich panels, but also it may be consisted of at combination of sandwich panels and a coupling member.

As shown in FIG. 4, the coupling member comprises: a coupling insulating material 200a of a square pillar shape, a coupling exterior panel 100a coupled to cover at least one of outside surfaces of the coupling insulating material 200a, a coupling upper heat insulating plate 410a and a coupling lower heat insulating plate 420a made of a material having a higher melting point than the combustion heat of the coupling insulating material 200a to cross the coupling insulating material 200a horizontally, and a coupling water pipe. 300a made of a material capable of melting by the combustion heat of the coupling insulating material 200a, into a shape of 3-way valve or 4-way valve, and inserted between the coupling upper heat insulating plate 410a and the coupling lower heat insulating plate 420a. The coupling member is inserted and mounted between the ends of two sandwich panels arranged. orthogonally, and the coupling water pipe 300a can connect two water pipes 300 arranged orthogonally by arranging three or four inlets/outlets at a right angle of 90°.

That is, if a coupling member is further provided in addition to the sandwich panels as described above, a gap between two sandwich panels arranged orthogonally can be filled as shown in FIG. 5, even though the water pipes 300 included in the sandwich panels are formed in a linear shape. Further, water pipes 300 provided in the two sandwich panels may be communicating with each other to form a single passage in the Whole construction wall.

Furthermore, when the coupling water pipe 300a is formed into a 3-way valve structure, as in an embodiment shown in FIG. 5, i.e., has three inlets/outlets, two inlets/outlets are connected to different water pipes 300, but one inlet/outlet is not connected to any type of water pipes 300. At this time, if the inlet/outlet of the coupling water pipe 300a which is not connected to the water pipe 300 is left open water supplied inside is discharged outside through the open port among the inlet/outlet of the coupling water pipe 300a, whereby the water pipe 300 may not maintain a state in which it is filled with water inside.

Accordingly, a cap 500 for coupling detachably to the open inlet/outlet of the coupling water pipe 300a may be provided. The cap 500 is formed to seal the inlet/outlet of the coupling water pipe 300. As shown in FIG. 5, when the cap 500 is coupled to the end not connected to the water pipe 300 among the ends of the coupling water pipe 300a, the water supplied to the coupling water pipe 300a is not discharged outside and all water is supplied to the water pipes 300 of the sandwich panels.

The cap 500 may be coupled to the coupling water pipe 300a in screw-coupling or press-fitting structure. That is, the cap 500 may be coupled to the inlet/outlet of the coupling water pipe 300a only if it can seal the inlet/outlet of the coupling water pipe 300a.

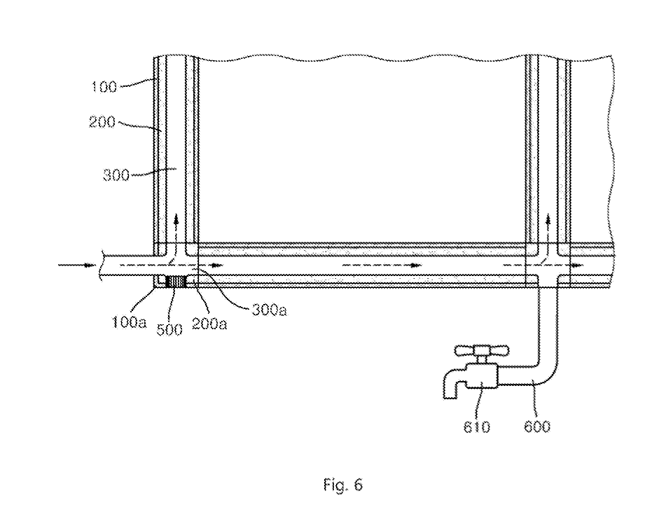

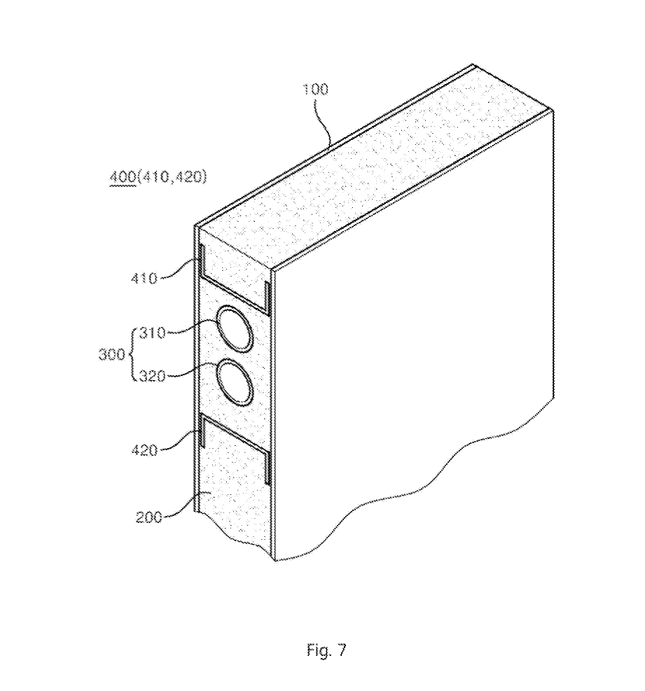

FIG. 6 is a cross-sectional view of a constriction wall in accordance with the second embodiment of the present invention, and FIG. 7 is a perspective view of a sandwich panel in accordance with the second embodiment of the present invention.

When the coupling water pipe 300a included in the coupling member is formed into a 4-way valve structure, i.e., a structure that 4 inlets/outlets are arranged to have a right angle of 90°, a drain pipe 600 on which a faucet 610 is mounted may be connected to an inlet/outlet formed extroverted (hereinafter, ‘an extrovert inlet/outlet’) to use the water pipe 300 and the coupling water pipe 300a as a supply water line. As described above, if the drain pipe 600 can be connected to the construction wall according to the present invention, water can be supplied, to each point of the construction structure without separate water pipes, which makes the pipe arrangement of the construction structure simple and the construction cost is greatly low accordingly.

Furthermore, if the water pipe 300 is consisted of a. hot water pipe 310 and a cold water pipe 320 separately, as shown in FIG. 7, hot water and cold water can be advantageously supplied separately. If both of the hot water pipe 310 and the cold water pipe 320 are provided in one sandwich panel, both cold water and hot water can be supplied and both water filled in the hot water pipe 310 and water filled in the cold water pipe 320 are discharged downwardly at the outbreak of fire, thus increasing two times the effects of suppressing the fire.

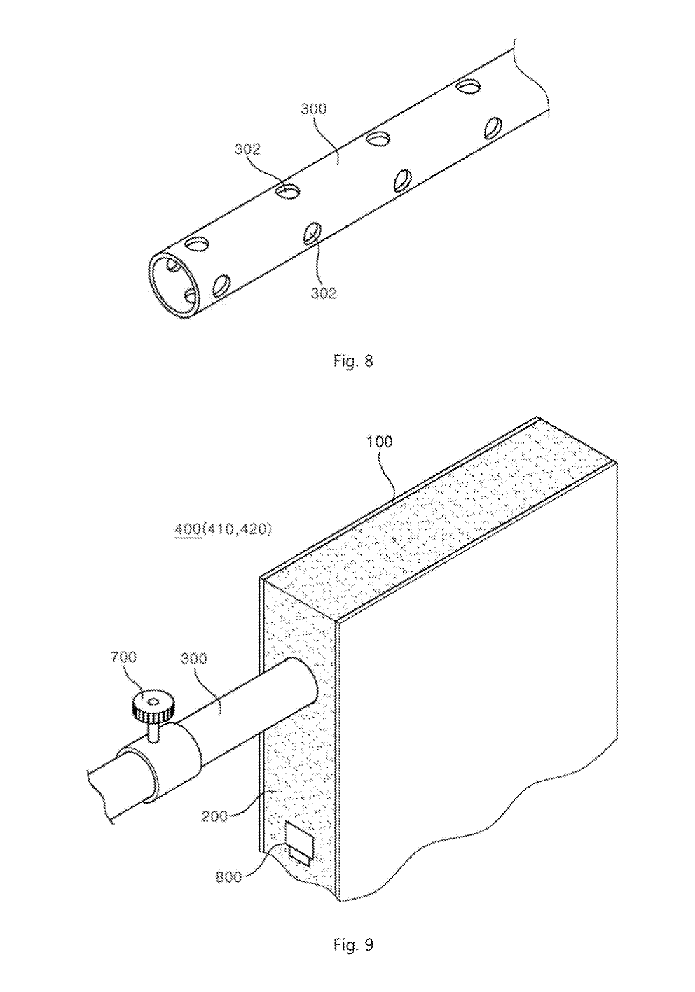

FIG. 8 is a perspective view of a water pipe included in a sandwich panel in accordance with the third embodiment of the present invention, and FIG. 9 is a perspective view of a sandwich panel in accordance with the third embodiment of the present invention.

As described with reference to the embodiments shown in FIGS. 1 through 6, if it is formed to have a structure that the water pipe 300 is melted by the combustion heat of the insulating material 200 at the outbreak of fire, only water filled in the water pipe 300 is discharged downwardly, but an additional supply of water is not achieved. Accordingly, if the fire is not extinguished by water filled in the water pipe 300, the sandwich panel may burn again. In addition, water in the water pipe 300 is not discharged until the insulating material 200 burns and the water pipe 300 melts. That is, water in the water pipe 300 is not discharged when the insulating material 200 starts to burn, which makes it difficult to quickly suppress the fire.

To solve the above-mentioned problems, the sandwich panel according to the present invention is formed such that the water pipe 300 is made of a nonflammable material, a plurality of through holes 302 are formed, and a water supply valve 700 for controlling water supply into the water pipe 300 is added.

In this embodiment, it is shown that the through holes 302 are formed on the upper and lower pans and on the left and right sides of the water pipe 300. However, the arrangement of the through holes 302 and distance between them may vary.

When the through holes 302 are formed in the water pipe 300 as described above, the state in which water is not filled, i.e., the empty state is usually maintained. At the breakout of fire, water is introduced inside by the operation of the water supply valve 700. The water introduced inside the water pipe 300 is injected inside the sandwich panel through the through holes 302 to extinguish the fire. If the water pipe 300 maintains the empty state at ordinary times during which fire does not break out, it is advantageous that frozen pipe or dew condensation phenomenon of the water pipe 300 does not occur when the temperature is low like the winter season. At this time, the water pipe 300 should be made of a nonflammable material for not to be melted at the outbreak of fire.

In the meantime, the water supply valve 700 can be configured to be opened manually by a user, or a temperature detecting sensor 800 for outputting an operating signal for the water supply valve 700 to be automatically opened when the temperature of the insulating material 200 rises over a predetermined value at the outbreak of fire may be provided additionally. In the present embodiment, it is shown that the temperature detecting sensor 800 is introduced in the insulating material 200. However, the temperature detecting sensor 800 may be mounted to adhere closely to the exterior panel 100 or on the water pipe 300. That is, the temperature detecting sensor 800 can be mounted at any point only if it can detect the state that sandwich panel is on fire.

Further, in addition to the temperature detecting sensor 800 or alternatively, a smoke detecting sensor can be included.

Although the specific embodiments of the present invention have been disclosed for illustrative purposes, those skilled in the art will appreciate that various modifications, additions and substitutions may be made to the invention without departing from the scope and spirit of the invention as disclosed in the accompanying claims.

### DESCRIPTION OF REFERENCE NUMERALS

100: exterior panel 200: insulating material
300: water pipe 302: body
304: through hole 306: low melting point packing
310: hot water pipe 320: cold water pipe
400: beat shield plate 410: upper heat shield plate
420: lower heat shield plate 500: cap
600: drain pipe 610: faucet
700: water supply valve 800: temperature detecting sensor

What is claimed is:

1. A construction wall which comprises:
a sandwich panel including a pair of exterior panels (100) spaced from each other, an insulating material (200) filled between a pair of exterior panels (100), an upper heat insulating plate (410) and a lower heat insulating plate (420) made of a material having a higher melting point than the combustion heat of the insulating material (200) and inserted to cross the insulating material (200) horizontally, and a water pipe (300) made of a material capable of melting by the combustion heat of the insulating material (200), inserted between the upper heat insulating plate (410) and the lower heat insulating, plate (420), and maintaining a state where water is filled inside:
a coupling member which includes a coupling insulating material (200a) of a square pillar shape, a coupling exterior panel (100a) coupled to cover at least one of outside surfaces of the coupling insulating material (200a), a coupling upper heat insulating plate (410a) and a coupling lower heat insulating plate (420a) made of a material having a higher melting point than the combustion heat of the coupling insulating material (200a) and inserted to cross the coupling insulating material (200a) horizontally, and a coupling water pipe (300a) made of a material capable of melting by the combustion heat of the coupling insulating material (200a), into a shape of 4-way valve, and inserted between the coupling upper heat insulating plate (410a) and the coupling lower heat insulating plate (420a), wherein the coupling member is mounted such that two sandwich panels arranged orthogonally are connected and the coupling water pipe (300a) is communicating with the water pipe (300) of the sandwich panel;
a drain pipe (600) connected to at least one extrovert inlet/outlet among extrovert inlets/outlets of the coupling water pipe (300a), in which a faucet (610) is mounted one end thereof, and
a cap (500) coupled detachably for sealing an extrovert inlet/outlet which is not connected to the drain pipe (600) among extrovert inlets/outlets of the coupling water pipe (300a), wherein
a water supply is available to the outside through the faucet (610).
